(19) United States
(12) Patent Application Publication
(10) Pub. No.: US 2004/0201793 A1
(43) Pub. Date: Oct. 14, 2004

(54) Automatic background color change of a monochrome liquid crystal display

(75) Inventors: Munisamy Anandan, Del Valle, TX (US); Michael Graziano, Austin, TX (US)

Correspondence Address: Dr. M. Anandan, 13009 Thome Valley Dr., Del Valle, TX, 78617, US

(73) Assignee: Organic Lighting Technologies LLC, Austin, TX

(21) Appl. No.: 10/815,020

(22) Filed: Mar. 31, 2004

Related U.S. Application Data
(60) Provisional application No. 60/461,098, filed on Apr. 8, 2003.

(51) Int. Cl. G02F 1/1335

(52) U.S. Cl. 349/61

(57) ABSTRACT

An assembly for automatic background color change of a monochrome liquid crystal display comprising a monochrome liquid display, a dichroic guest-host cell, and a backlight device, emitting light in visible region of the spectrum. The devices are arranged in a sequence of, from top to bottom, liquid crystal display, dichroic cell and backlight device. The dichroic cell comprising a single dye or combination of dye, together with liquid crystal molecules, absorbing characteristic wavelengths from the spectrum of the backlight device and transmitting the remaining wavelengths, on application of suitable voltage to the cell. The assembly is integrated to form a single unit in which the three devices namely, liquid crystal display, dichroic cell and white light emitting backlight share at least one substrate with each other. On application of different amplitude of voltage to the dichroic cell, hues of colors as background colors for monochrome liquid crystal display is generated.

### CROSS REFERENCE TO RELATED APPLICATION

Benefit of Provisional application No. 60/461,098 filed Apr. 8, 2003

U.S. Pat. No. 5,748,828—Steiner, et al. May 5, 1998

U.S. Pat. No. 6,657,607—Evanicky, et al. Dec. 2, 2003

U.S. Pat. No. 6,050,704—Park, Apr. 18, 2000

### OTHER PUBLICATIONS

“Liquid Crystals/Applications and uses”, vol. 3-Edited by Birendra Bahadur, Publisher: World Scientific, Singapore, N.J. (USA), 1992

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention relates to a method of automatically changing the background color of a monochrome Liquid Crystal Display through a liquid crystal dye-based color changing element, a voltage dependent color filter, placed between a backlight device and liquid crystal display. More particularly, the present invention utilizes a dichroic liquid crystal cell, a white backlight device and a monochrome LCD of a cell phone to change the background color of cell phone screen, on demand. Depending on the source of the call, number of the telephone, a programmed signal reaches the dichroic liquid crystal cell to change the color of the backlight falling on the main liquid crystal display. If the numbers are pre-programmed, the change in the background color indicates the nature of message and the caller. Thus, it is not necessary to look at the caller's number on cell phone screen to know the source of call. The LCD, meant in this invention, is a normal monochrome LCD without built-in color filters. However, this method of changing the background color is not required for cell phones employing color LCDs, in that, the color of the screen can be changed by LCD itself.

Cell phone screen is back-lit by a backlight device and for monochrome cell phones, blue, green or red colors are available through different colors of Light Emitting Diodes employed for the backlight. These colors can not be changed on demand and is fixed for a cell phone handset. Special backlight options, utilizing two or three sets of LEDs of three colors, can be thought of, to change the background color of LCD screen, on demand. No such backlight option exists. Additionally, to change the background color of monochrome cell phone LCD to hues of colors, on demand, is not known in the art.

Prior arts employed backlights comprising different color light sources for obtaining refined color images on the LCD screen. In one prior art of 1998 (U.S. Pat. No. 5,748,828), Steiner et. al described a wave-guide and a diffraction element, placed between a fluorescent backlight assembly and a LCD, that diffracted three red, blue and green colors of light from the fluorescent backlight and focussed the three colors to the sub-pixels of LCD. The purpose of this arrangement was to eliminate the color filters of the LCD, which absorbed 80% of light. In this case, the combined color falling on the back of LCD was still white and the LCD used was not monochrome but full color. In another prior art of 2003, Evanicky et. al (U.S. Pat. No. 6,657,607) disclosed the selection of different color light sources of the backlight assembly to adjust the color temperature, close to CIE of black body radiation, on the LCD screen. Here again, the resultant color of light incident on the back of LCD, which was not a monochrome LCD, was white. In 2000, Park described (U.S. Pat. No. 6,050,704) a method of improving the color quality of LCD screen by employing fluorescent lamps of different wavelengths in the backlight assembly and adjusting their intensity. In this case, the LCD employed was of full color and not monochrome.

In all the foregoing prior arts, no voltage dependent color filter element was used between the backlight and LCD and the LCD employed was not monochrome. Background color change is needed only for monochrome LCD. For color LCD, change in color can be accomplished by LCD itself.

### BRIEF SUMMARY OF THE INVENTION

The present day mobile phone or cell phone, employing monochrome LCD, provides the end user to know the name and phone number of the caller by displaying caller information in the form of text. When the phone is away, still within the vicinity, from the user, it is impossible to know nature of the caller and the message at a quick glance. This invention provides a special feature and option to know the information at a quick glance, in such a situation. The feature relates to the automatic background color change to various colors, pre-programmed on the cell phone hand set. For example, on receiving an emergency message, the background color may change to ‘red’. On receiving a message from kith and kin, the background color may change to ‘green’. On receiving a message from a close friend, the background color may change to ‘blue’; on receiving a message from an employer, the background color may change to orange; on receiving a message from a student, the background color may change to pink and so on. In this manner ‘hues’ of colors can be employed to know, at a quick glance, the nature of caller and the message.

To provide this special feature on the screen of a cell phone, employing monochrome LCD, normally without built-in color filters, this invention employs two critical elements behind the monochrome LCD namely, a voltage dependent color filter and a white backlight device. Depending on the voltage applied, the color filter can filter a band of wavelength from the white light and present a resultant color of light to the back of LCD, which serves as the background color for the LCD. The voltages are pre-programmed for different types of messages and callers based on their telephone numbers. This invention relates to a method of background color change of monochrome LCD through the assembly of a voltage dependent color filter and a white backlight device behind the LCD and a method for fabricating an integrated assembly. The white backlight device can be from any technology and may include white LED backlight with light guide or white planar OLED or planar white Electro-luminescent backlight or white fluorescent backlight. On electrical excitation of white backlight, a visible white spectrum starting from 400 nm to 700 nm emerges. This light falls on a voltage dependent color filter comprising two glass substrates with two transparent electrodes, between which is sandwiched a liquid crystal film, doped with dye molecules of either one type or two types. The voltage dependent color filter is also known as ‘guest-host’ LC cell or ‘dichroic’ cell. Upon application of sufficient voltage to the ‘dichroic’ cell, the LC molecules can be made to take a vertical or horizontal orientation, with respect to the substrates, depending on the dielectric anisotropy of the LC molecules. The dye molecules will follow the orientation of LC molecules, also depending on the anisotropy of dye molecules. If insufficient voltage is applied, the orientation may not be complete. White light incident on the ‘dichroic’ cell will undergo absorption of certain band of wavelength, depending on the orientation of the dye molecules, and the resulting light emerging from the ‘dichroic’ cell will be a colored light as against white light in the absence of ‘dichroic’ cell. For voltages of different values, the orientation of the dye molecules can be made vertical or horizontal or in between vertical and horizontal positions. Accordingly, the absorption characteristics will change and the emerging color will change. The ‘dichroic’ cell can have two types of dye molecules that have different absorption characteristics and hence ‘hues of colors’ can be obtained from the ‘dichroic’ cell. The color presented by the ‘dichroic’ cell to the LCD will be the background color. As the main three devices of this invention are low temperature compatible devices, the substrates of these devices can be shared by one another for reducing the overall thickness, weight and cost, in addition to the simplification of processes.

It is an object of this invention to provide an automatic programmed background color change of a monochrome LCD employed in any display system, particularly in cell phone hand-set. This invention comprises three critical devices, which can be readily manufactured.

A further object of this invention is to provide ‘hues’ of background colors for the LCD by doping the ‘dichroic’ cell with two types of dye molecules at predetermined doping levels.

Yet another object of this invention is to provide a simplified method of manufacture of the three critical devices namely, LCD, dichroic cell and a planar backlight as an integrated single device, rendering the devices more compact, light weight and low cost.

### BRIEF DESCRIPTION OF THE DRAWING

FIG. 1 is a top down view of the assembly, of the three critical devices, illustrating the arrangement of these devices in an appropriate sequence in accordance with the present invention.

FIG. 2 shows the typical spectrum of a white light from a fluorescent backlight device.

FIG. 3 shows the absorption spectrum of a ‘blue’ dye.

FIG. 4 is a cross section of a ‘dichroic’ cell comprising the LC molecules and dye molecules, when no voltage is applied to the cell.

FIG. 5 is a cross section of a ‘dichroic’ cell comprising the LC molecules and dye molecules in the orientation when a voltage of sufficient magnitude is applied to the cell.

FIG. 6 is a cross section of a ‘dichroic’ cell comprising LC molecules and two types of dye molecules when no voltage is applied to the cell.

FIG. 7 is a cross section of a ‘dichroic’ cell comprising LC molecules and two types of dye molecules when a voltage of sufficient magnitude is applied to the cell.

FIG. 8 is a cross section of LCD, ‘dichroic’ cell and planar backlight assembled in appropriate sequence.

FIG. 9 is a cross section of a compact integrated structure of three devices.

### DETAILED DESCRIPTION

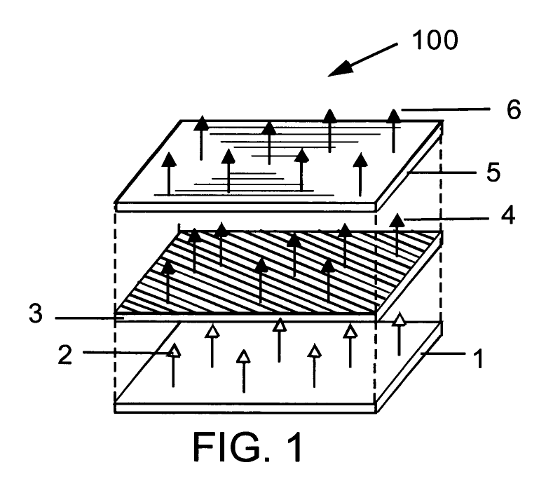

FIG. 1 shows the top-down view of the assembly 100 of three key devices in accordance with this invention. The backlight device 1 emits white light 2 in a wide band of visible wavelength. This white light passes through a dichroic cell 3, which selectively absorbs certain wavelengths in the absence of any applied voltage to the cell. The transmitted light 4 has a different color, characteristic of the dye being employed in the cell, and is incident on a monochrome LCD 5. If the dye employed is a blue dye, the transmitted light to LCD is blue. LCD transmits this color as a background color of light 6. All other conditions being the same, if a voltage of sufficient magnitude is applied to the dichroic cell 3, the cell transmits the white light without any absorption. Thus, in the illustration shown, the background color of the display can be switched from blue to white. With a combination of color of backlight, dye and the magnitude of voltage, desired background color of the display is obtained. Examples of backlight 1, which emit white light, include OLED backlight, LED backlight, EL backlight, fluorescent backlight or vacuum fluorescent backlight. Similarly the examples of monochrome LCD, which transmits the background color of light from ‘dichroic’ cell include twisted nematic liquid crystal display, ferro-electric liquid crystal display, polymer dispersed liquid crystal display, super-twisted nematic liquid crystal display.

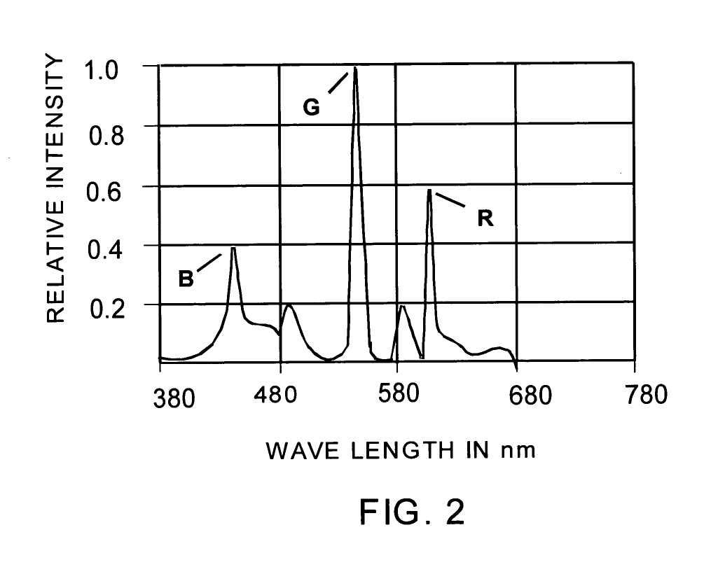

FIG. 2 shows a typical spectrum emitted by a fluorescent backlight device. There are peaks in red R, blue B and green G covering all the visible wavelengths. When this spectrum is incident on the ‘dichroic’ cell, the ‘dichroic’ cell absorbs a band of wavelengths based on the absorption characteristics of the dye employed and transmits other wavelengths.

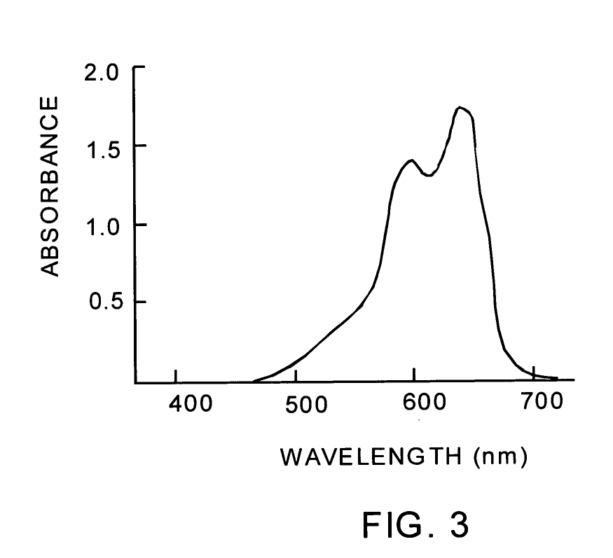

FIG. 3 shows the absorption characteristics of a ‘blue’ dye, as an example. As can be seen from the spectrum, the blue dye exhibits different absorption coefficients for different wavelengths of the spectrum. Starting from minimum absorption around 475 nm, the absorption gradually increases in green region, from 500 to 580 nm, and red region, from 600 nm to 640 nm, and then gradually decreasing till 700 nm. It can be observed that the absorption in blue region of the spectrum is negligible. The net result is the transmission of blue region of the spectrum from ‘dichroic cell to the LCD with negligible intensity in green.

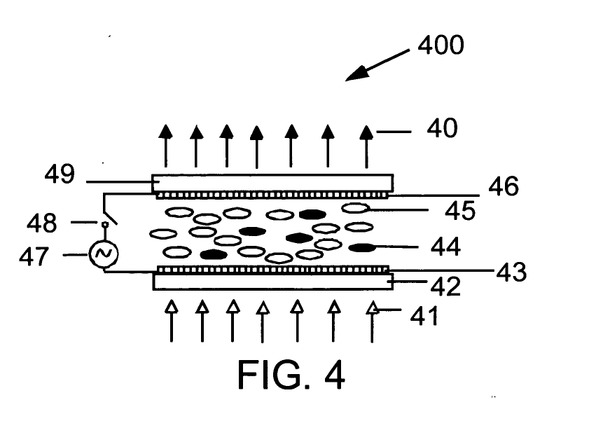

FIG. 4 is a cross section of a ‘dichroic’ cell 400 illustrating the orientation of dye molecules and LC molecules when no voltage is applied to the cell. The LC molecules depicted here for illustration purposes have positive dielectric anisotropy, i.e, the dipole moment is along the long axis of the molecule and have planar structure. The cell comprises two glass substrates 49 and 42 that contain transparent electrodes 43 and 46, for example Indium Tin Oxide, on the inner surfaces. Between the transparent electrodes are disposed liquid crystal molecules 45 and dye molecules 44. To orient these molecules horizontal to the substrate, a surface alignment layer, not shown in the FIG. 4 is usually formed over the transparent electrodes 43 and 46. The orientation of the molecules shown in FIG. 4 is known as ‘homogeneous’ alignment. The cell is connected in series with a source of supply voltage 47 and a switch 48. In the illustration, the switch 48 is open and hence no voltage is applied to the cell. In this state, light 41, coming from backlight device and incident on the cell at the bottom, will undergo absorption by the dye molecules, while passing through the cell. The emerging light 40 from the cell will be blue, if the dye molecules are from the class of ‘blue dye’. The dye molecules are sometimes called as ‘guest’ and the LC molecules are called ‘host’ and hence the term ‘guest-host cell’. The intensity of absorption depends on the concentration of dye molecules in the LC molecules. If the absorption becomes heavy, the brightness will decrease. Typical concentration of the dye molecules is 1%-10% in the host.

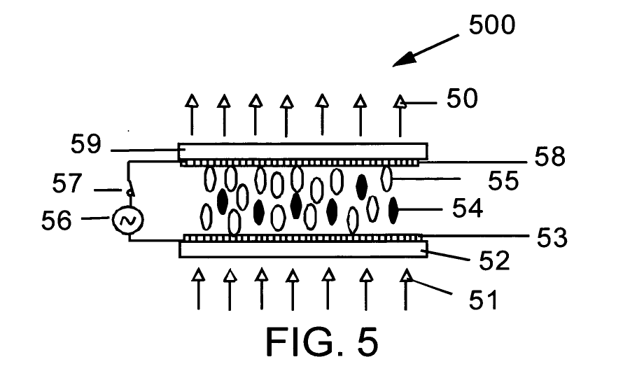

FIG. 5 is the cross section of the ‘dichroic’ cell 500 under electric filed. A voltage of sufficient magnitude is applied from the voltage source 56 through the switch 57. The electric field, created inside the cell through the electrodes 58 and 53, orients the LC molecules 55 and dye molecules 54 to ‘homeotropic’ orientation, i.e long axes of the molecules are perpendicular to the substrates 59 and 52. The LC molecules in this illustration have positive dielectric anisotropy and hence their long axes orient along the direction of the electric field. In this orientation, the white light 51 incident on the ‘dichroic’ cell passes through without absorption. The emerging light 50 and hence the background color of the LCD will be white. The illustration given in FIG. 4 and 5 is for changing white background to blue background. Colors in between are also possible. Above a certain threshold voltage to the cell, the long axes of the LC molecules and dye molecules can take orientation at angles between vertical and horizontal directions. Various angles are possible for various voltage levels. Under these circumstances, depending on the angle of the long axes of the dye molecules, absorption for green and red light will occur to varying degrees. The resultant light will exhibit shades of colors.

It is also possible to mix positive dichroic dye and negative dichroic dye in LC molecules. Negative dichroic dye molecules exhibit absorption of light when their long axes are vertical to the substrate i.e in homeotropic alignment. Thus when the voltage is applied, the negative dichroic dye molecules absorb the incident light and the positive dichroic dye does not absorb the incident light. If the negative dichroic dye is ‘green’ dye and the positive dichroic dye is ‘blue’ dye, then the emerging light, on application of voltage, will be ‘green’ color. When the voltage is off, the emerging light will be ‘blue’ color. If the value of the voltage applied is such that the dye molecules are in a state in between ‘homeotropic’ and ‘homogenous’, then a combination of blue and green color will result. Thus it is possible to switch three background colors and ‘hues’ of colors. This will be attractive in cell phones both for technical reasons and cosmetic reasons.

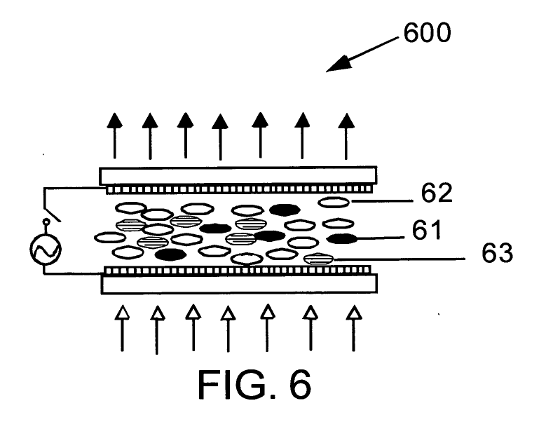

FIG. 6 is the cross section of a mixed ‘dichroic’ cell 600 with positive ‘dichroic’ molecule 61 and negative ‘dichroic’ molecule 63 mixed with LC molecule 62, when no voltage is applied to the cell. Under this condition, the positive ‘dichroic’ molecule 61, blue dye, absorbs a band of wavelength of the incident light and the negative ‘dichroic’ molecule 63, green dye, does not absorb the incident light. Hence the transmitted light to the LCD is blue.

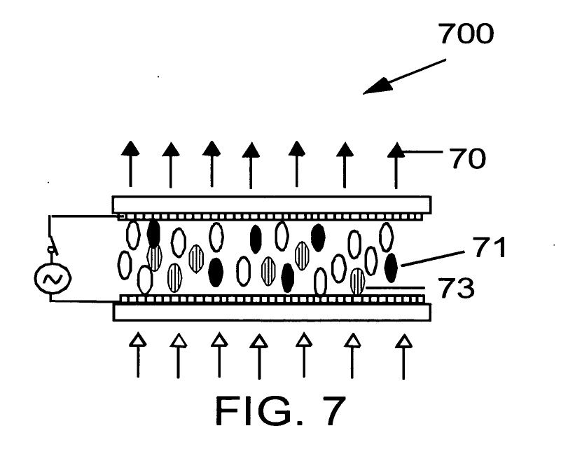

FIG. 7 is the cross section of a mixed ‘dichroic’ cell 700 when a voltage of sufficient magnitude is applied to the cell. Under this condition, positive ‘dichroic’ molecule 71 does not absorb and the negative ‘dichroic’ molecule 73 will absorb the incident light and the resultant transmitted light 70 to the LCD will be green. For values of voltages between threshold and the fully ‘on’ stage (molecules are completely in ‘homeotropic’ alignment), there will result ‘hues’ of colors of the transmitted light.

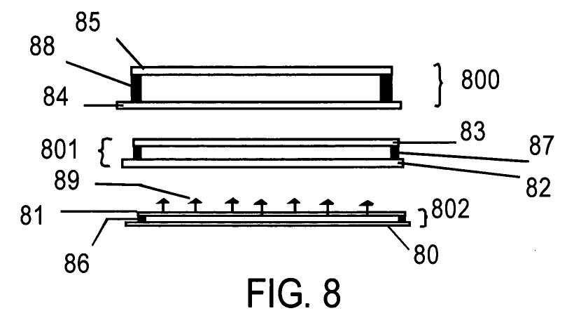

FIG. 8 is a cross-sectional view of the assembly of the LCD, dichroic cell and backlight. The LCD 800 is assembled at the top, followed by dichroic cell 801 and backlight 802. The assembly in a regular stack will be without any gap between the devices. For the sake of clarity in illustration the FIG. 8 depicts a gap between the devices. The top substrate 85, of LCD 800, is spaced from the bottom substrate 84 through a spacer 88. Similarly, the top substrate 83 of the dichroic cell 801 is spaced from its bottom substrate 82 through a spacer 87. In the same way, the top substrate 81 of the backlight device 802 is spaced from its bottom substrate 80 by the spacer 86.

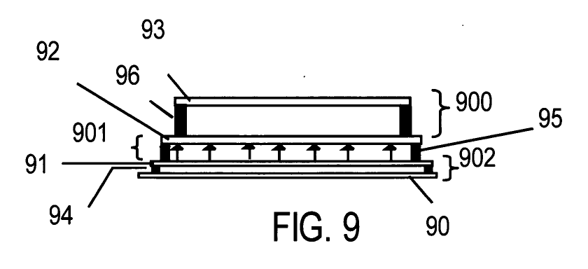

FIG. 9 shows another embodiment of the invention. FIG. 9 is a cross section of an integrated assembly of LCD, ‘dichroic’ cell and backlight. The LCD 900 has a top substrate 93 spaced from its bottom substrate 92 by a seal 96 which acts as a perimeter hermetic seal. The ‘dichroic’ cell 901 utilizes the bottom surface of the bottom substrate 92 of the LCD 900 and thus LCD 900 and ‘dichroic’ cell 901 share the substrate 92. The bottom substrate 91 of the ‘dichroic’ cell is spaced from substrate 92 by the seal 95 which acts as a perimeter hermetic seal. Backlight 902 utilizes the bottom surface of the bottom substrate 91 of the ‘dichroic’ cell 901. Thus ‘dichroic’ cell 901 and backlight 902 share the substrate 91. Finally, the bottom substrate 90 is spaced from the substrate 91 by the seal 94 which acts as a perimeter hermetic seal. Thus in this embodiment, only four substrates are necessary as against 6 substrates in the case of FIG. 8.

The embodiment shown in FIG. 9 can be manufactured. If the backlight employs a light guide, either edge-lit or directly-lit, ‘dichroic’ cell can be processed on the surface of the light guide material because the ‘dichroic’ cell fabrication process is a low temperature process. Similarly, LCD can be processed on the top surface of the top substrate of the ‘dichroic’ cell, because LCD process and ‘dichroic’ cell process are compatible. For LCDs employing polarizers, the internal polarizers are available from company like ‘Optiva’ to make this embodiment manufacturable. If the backlight is an Organic Light Emitting Diode backlight or flexible Electro-luminescence backlight, the ‘dichroic’ cell process, OLED process and flexible EL process are low temperature processes and hence compatible for fabrication. If all the three devices namely, LCD, ‘dichroic’ cell and backlight employ low temperature process, the sequence of fabrication starts with LCD first and backlight last or backlight first and LCD last. The sequence can also start with lowest yielding device first and the highest yielding device last. If the backlight is of flat fluorescent lamp, the sequence of operation starts with flat fluorescent lamp first because of its high temperature nature.

It will be apparent to those skilled in the art that various modifications and variations can be made in the construction, configuration and/or operation of the present invention without departing from the scope or spirit of the invention. For example, in the embodiments mentioned above, changes may be made to the type of dye material inside ‘dichroic’ cell. Dichroic cell may be operated in a different mode or monochrome LCD may be from a different family or electro-phoretic cell may be replaced with LCD or field emission lamp may be used as backlight or ‘dichroic’ cell may be replaced with LC shutter with electrically controlled birefringence effect. Instead of one white backlight, red, blue green color backlight may be used in combination with one or more ‘dichroic’ cells. As illustrated in FIGS. 4, 5, 6 and 7, the dye molecules are doped in LC molecules having planar structure without any twist. Variation of this is to dope the dye molecules in LC molecules having twisted structure. This invention particularly relates to the cell phone LCD, however variations of this invention may be applied to other monochrome LCDs namely, super-twist LCD, Ferro-electric LCD and polymer dispersed LCD. Thus it is intended that the present invention covers the modifications and variations of the invention provided they come within the scope of the appended claims and their equivalents.

We claim:

1. A novel automatic background color change assembly for a monochrome LCD comprising:
a white light emitting backlight device, serving as source of light for a monochrome LCD;
a dichroic cell serving as a voltage dependent color absorption medium;
a liquid crystal monochrome display that displays information with a background color supplied by the said dichroic cell;
said dichroic cell receiving the light from the said white backlight device;
said white backlight device over which is assembled the said ‘dichroic’ cell over which is assembled the said monochrome LCD to be in alignment;
said ‘dichroic’ cell applied with programmed voltages that relates to the information being displayed on LCD screen;
said monochrome LCD exhibiting the background color as supplied by the said dichroic cell;
means for externally connecting the said LCD, the said dichroic cell and the said backlight device to their source voltages.

2. An automatic background color change assembly as claimed in claim 1 wherein the said monochrome LCD is removed and the resulting assembly is used as color changeable backlight assembly.

3. An automatic background color change assembly as claimed in claim 1 wherein the said dichroic cell is replaced with Electrically Controlled Birefringence liquid crystal cell.

4. An automatic background color change assembly as claimed in claim 1 wherein the said liquid crystal display is replaced with an Electro-phoretic cell.

5. An automatic background color change assembly as claimed in claim 1 wherein the number of said dichroic cell is more than one.

6. An automatic background color change assembly as claimed in claim 1 wherein the assembly is used in cell phones for changing the background color of LCD depending on the source of information and nature of information.

7. An automatic background color change assembly as claimed in claim 1 wherein the said backlight device emits bands of wavelengths between 400 nm and 700 nm.

8. An automatic background color change assembly as claimed in claim 1 wherein the said monochrome LCD, the said dichroic cell and the said backlight device are intimately placed in contact with each other in a flat panel display system.

9. An automatic background color change assembly as claimed in claim 1, wherein the said dichroic cell comprises LC molecules of positive dielectric anisotrpy.

10. An automatic background color change assembly as claimed in claim 1, wherein the said dichroic cell comprises LC molecules of negative dielectric anisotrpy.

11. An automatic background color change assembly as claimed in claim 9 wherein the said dichroic cell comprises LC molecules of positive dielectric anisotrpy and a combination of positive and negative dichroic dye molecules.

12. An automatic background color change assembly as claimed in claim 10 wherein the said dichroic cell comprises LC molecules of negative dielectric anisotrpy and a combination of positive and negative dichroic dye molecules.

13. An automatic background color change assembly as claimed in claim 9 and 10 wherein the said dye molecules in the said dichroic cell comprises concentration of dye molecules in the range of 0.1% to 30%.

14. An automatic background color change assembly as claimed in claim 13 wherein the said dichroic cell comprises dye molecules absorbing characteristic wavelengths ranging from 400 nm to 700 nm.

15. An integrated assembly of a novel automatic background color change for a monochrome LCD comprising:
a liquid crystal monochrome display having a top substrate whose inner surface is facing the inner surface of its bottom substrate;
said bottom substrate having its outer surface, serving as the inner surface and top substrate of a dichroic cell;
said dichroic cell sharing the bottom substrate of the said liquid crystal display as its top substrate;
said dichroic cell having it's inner surface of its bottom substrate facing the inner surface of its top said shared substrate;
said dichroic cell whose outer surface of its bottom substrate serving as inner surface of a backlight device;
said backlight device sharing the bottom substrate of the said dichroic cell as its top substrate;
said backlight device having its inner surface of its bottom substrate facing the inner surface of its top shared substrate;
said substrates of said liquid crystal display, said dichroic cell and said backlight device are all bonded together through a perimeter seal to form an integrated assembly;
means for externally connecting the said LCD, the said dichroic cell and the said backlight device to their source voltages.

16. An automatic background color change assembly as claimed in claims 1 through 29 and employed in end-user display systems to alert the user on emergency messages automatically switching the background color.

17. An automatic background color change assembly as claimed in claims 1 through 17 and employed in hand-held and mobile wireless phone application to distinguish the caller.
